(19) United States
(12) Patent Application Publication
(10) Pub. No.: US 2012/0019217 A1
(43) Pub. Date: Jan. 26, 2012

(54) CONTROL CONCEPT FOR A DIGITALLY CONTROLLED MAGNETIC SUPPLY DEVICE

(75) Inventor: Felix Jenni, Brugg (CH)

(73) Assignee: PAUL SCHERRER INSTITUT, VILLIGEN PSI (CH)

(21) Appl. No.: 13/254,867

(22) PCT Filed: Feb. 18, 2010
(86) PCT No.: PCT/EP2010/052073

§ 371 Date: Sep. 6, 2011

(30) Foreign Application Priority Data
Mar. 4, 2009 (EP) 09 154 343.9

(51) Int. Cl. G05F 1/10

(52) U.S. Cl. 323/234

(57) ABSTRACT

A method and a device control a magnetic supply device. The method includes the steps of executing a base structure of a control as a two-loop control having a voltage control loop for a magnetic voltage and a current control loop for the magnetic current, wherein the two control loops or circuits are preferably combined into one controller. The voltage control loop is executed as a status controller, wherein the return parameters for the status controller are adaptively adjusted as necessary to the behavior of a current converter, an output filter and a load. The behavior of the current converter, the output filter and the load are modeled by an observer (e.g. Luenberger observer, Kaiman filter) and the observer adapted to the effective behavior of the current converter, the output filter and the load is tracked. Finally, the current control loop is implemented as an adaptive PI controller.

The present invention relates to a method and device for setting a digitally controlled magnet power-supply device.

High-precision magnet power-supply devices are required for particle accelerators. A fundamental wish therein is for both existing and new devices to be further enhanced in their precision. The present situation and the way to enhance the quality of existing supply devices are briefly presented below:

The precision and speed of magnet power-supply devices (of controlled systems in broad terms) are determined for a given structure by the speed of the overall system (frequency response) and by the loop gain.

The frequency response and loop gain are limited by:
The type and mathematical order of the system being controlled → stability
Delays in measuring (analog-to-digital conversion, ADC) and converting the desired value in the actuator (power or other converter)
Measurement noise and noise within the system → limit the loop gain
The type of control employed (proportional integral derivative (PID) controller, status controller, linear/non-linear controlling, adaptive structure, continuous-time/discrete-time controlling . . . ).

Present-day adaptive PI (proportional integral) controllers have taken the speed and precision of digitally controlled supply devices virtually to their limits. Given the same control structure, faster and more precise devices can be realized only by increasing the switching frequencies of the semiconductors and the speed of the control cycles. For a given device performance, the switching speeds of semiconductors are determined in advance by the elements that are commercially available. Since the technological boundaries of semiconductors change only slowly, in the coming years only a slow increase in precision and speed will be possible via that avenue.

For very fast devices it is therefore necessary to boost the performance capability of the digital control means employed. That is done on the one hand by continuously improving the control hardware and, on the other, by improving the implemented control structure.

PID structures are used for the control means whenever possible. Apart from being “relatively simple” in design, PID controllers are generally robust, meaning that good results will be obtained even when the design is not fully optimal (typically involving loads that do not behave exactly as modeled), and the controlled systems are stable. Their characteristics can be even further improved when expansions are made to include adaptive properties, “anti-wind-up” etc. That is the tried-and-tested control structure of today's devices.

Better results in control terms can be achieved using status controllers. When set up to full capacity they process all the internal “statuses” (currents and voltages) of the system being controlled. One drawback that can occur therein is that not all said statuses are measurable.

The object of the invention is hence to disclose a method and device for controlling a magnet power-supply device by means of both of which the robustness of the control concept will be enhanced, the reaction times of the control concept will be further reduced, and the precision of the control concept will be further improved.

Said object is inventively achieved in terms of the method by providing a method for controlling a magnet power-supply device, which method includes the following steps:

a) Implementing a basic structure of the control means as a two-loop control means having a voltage control loop for the magnet voltage and a current control loop for the magnet current, with the two control circuits being preferably combined in a single controller;

b) Implementing the voltage control loop as a status controller, with the feedback parameters for the status controller being adaptively adjusted as necessary to the behavior of a current converter, output filter, and load;

c) Modeling the behavior of the current converter, output filter, and load by means of an observer (Luenberger observer, Kalman filter) and adjusting the observer to match the effective behavior of the current converter, output filter, and load; and

d) Implementing the current control loop as an adaptive PI controller.

Said object is inventively achieved in terms of the device by means of a device for controlling a magnet power-supply device, which device includes the following components:

a) A basic structure of the control means in the form of a two-loop control means having a voltage control loop for the magnet voltage and a current control loop for the magnet current, with the two control circuits being preferably combinable in a single controller;

b) The voltage control loop is implemented as a status controller, with the feedback parameters for the status controller being adaptively adjustable as necessary to the behavior of a current converter, output filter, and load;

c) An observer for modeling the behavior of the current converter, output filter, and load, with the observer being adjustable to match the effective behavior of the current converter, output filter, and load; and

d) The current control loop is implemented as an adaptive PI controller.

This system model can in that way with the aid of the observer achieve improved robustness compared with the controller known from the prior art. The course of the observer is therein continuously adjusted to match the physical system's behavior as precisely as possible. System behavior can be dependent on the instant in time and working point. This negative influences on controlling can be reduced and robustness increased as a result of automatically adapting the controller's setting parameters.

In an advantageous embodiment of the present invention it is possible to perform identifying of the output filter and load on the fully installed magnet power-supply device for calculating and adapting the control coefficients. The basic function and its associated parameters can hence in that way be cleanly determined. Identifying can additionally be performed in a special operating mode during which parameters can be obtained that are as operationally realistic as possible. Identifying can, though, alternatively also be performed continuously during operation.

In another advantageous embodiment of the present invention it is furthermore possible to provide limits for the correct functioning of controlling that are relevant to protection as well as protection functions for the current converter (di/dt limits, for example, where necessary). The control structure can therein be realized typically on a discrete-time basis.

Preferred exemplary embodiments of the present invention are explained in more detail with the aid of the following drawings:

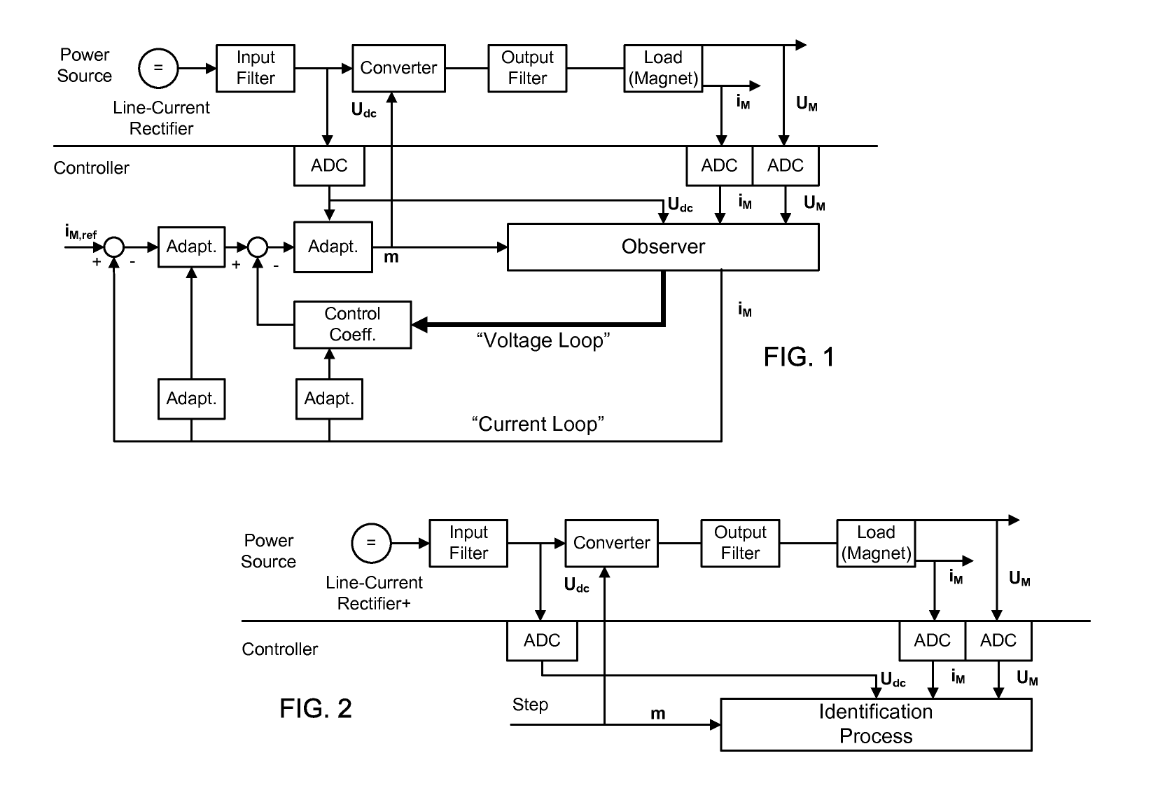

FIG. 1 is a schematic of a block diagram of a magnet power-supply device controlled according to the invention; and

FIG. 2 is a schematic of a block diagram for the identification of a magnet power-supply device's filter and load

An exemplary embodiment has been implemented in a corrector supply device of the following design:

The basic structure of the control means is implemented on a “two-loop” basis. There is a voltage control loop for the magnet voltage and a current control loop for the magnet current. The two control circuits can therein also be combined in a single controller.

The voltage control loop is implemented as a status controller. The feedback parameters are adaptively adjusted as necessary to the behavior of the current converter, output filter, and load. Because the voltages on and currents in the output of the actuator and in the filter produce noise and have a large ripple content they cannot simply be measured and used for the status controller's feedback. The current converter, output filter, and load are therefore modeled by means of an observer (Luenberger observer, Kalman filter). The observer is adjusted to match the effective behavior of the circuit.

Finally the current control loop is realized as an adaptive PI controller. Identifying of the output filter and load is performed on the fully installed device (which is to say having a load) for calculating and adapting the control coefficients. Said identifying is currently performed in a special operating mode. It would also be possible to perform identifying continuously during operation. The necessary limits for the correct functioning of controlling as well as protection functions for the current converter (di/dt limits, for example, where necessary) have been provided. The definitive control structure has been realized on a discrete-time basis.

Simple magnet power-supply devices having a digital control structure suffer from three main disadvantages which at least can be moderated when the inventive solution according to FIG. 1 is used:

1. The internal statuses of the current converter, filter, and load cannot be purposefully measured as they are greatly distorted owing to the switched semiconductor operation. No status feedback is possible with those signals. Their corresponding images in the observer will, however, be undistorted, as a result of which fast controlling can be realized.

2. The data conversions in the analog-to-digital converters (ADC) and the transferring of data to the processor (controller) cause a delay which limits the speed of controlling. If the hardware model is good, then for fast processes the model's internal values can be used for controlling—the model itself will be adaptively adjusted more slowly to the effective values. That approach will make it possible in certain applications to use slower but more precise AD converters.

3. With conventional control means an expedient control cycle is at most as fast as an AD-converter cycle. That cycle time is a highly restricting quantity in the case of precise converters. In this selected application of the observer data the control data can be selected independently of the AD converter as quickly as is still expedient in terms of the semiconductors' controllability.

A precise system description (model) is necessary for determining the controller parameters. The data is in practice determined on the fully installed devices.

A numeric system map is computed from the data of the measured step responses of the load voltage and current using multidimensional optimizing. The controller coefficients are then determined from said map. The data is measured using a magnet power-supply device and the associated controller. Determining the system map and computing the controller coefficients are currently still carried out on a PC. The coefficients are then loaded into the controller and the system runs autonomously. The schematic block diagram shown in FIG. 2 applies to that operation.

1-12. (canceled)

13. A method for controlling a magnet power-supply device, which comprise the steps of:
implementing a basic structure of a control means as a two-loop control means having a voltage control loop for a magnet voltage and a current control loop for a magnet current;
implementing the voltage control loop as a status controller, with feedback parameters for the status controller being adaptively adjusted as necessary to behavior of a current converter, an output filter, and a load;
modeling a behavior of the current converter, the output filter, and the load by means of an observer and adjusting the observer to match an effective behavior of the current converter, the output filter, and the load; and
implementing the current control loop as an adaptive PI controller.

14. The method according to claim 13, which further comprises identifying the output filter and the load on a fully installed magnet power-supply device for calculating and adapting control coefficients.

15. The method according to claim 14, which further comprises performing the identifying step in a special operating mode.

16. The method according to claim 14, which further comprises performing the identifying step continuously during operation.

17. The method according to claim 13, which further comprises providing limits for a correct functioning of controlling that are relevant to protection as well as protection functions for the current converter.

18. The method according to claim 13, wherein a control structure is realized on a discrete-time basis.

19. The method according to claim 13, which further comprises:
forming the adaptive PI controller and the status controller as a single controller; and
selecting the observer from the group consisting of a Luenberger observer and a Kalman filter.

20. A device for controlling a magnet power-supply device, the device comprising:
a control means being a two-loop control means having a voltage control loop for a magnet voltage and a current control loop for a magnet current;
said voltage control loop being a status controller with feedback parameters for said status controller being adaptively adjustable as necessary to a behavior of a current converter, an output filter, and a load;
an observer for modeling a behavior of the current converter, the output filter, and the load, said observer being adjustable to match an effective behavior of the current converter, the output filter, and the load; and
said current control loop being an adaptive PI controller.

21. The device according to claim 20, wherein it being possible to perform an identification of the output filter and the load on a fully installed magnet power-supply device for calculating and adapting control coefficients.

22. The device according to claim 21, wherein it being possible to perform the identification in a special operating mode.

23. The device according to claim 21, wherein it being possible to perform the identification continuously during operation.

24. The device according to claim 20, wherein limits for a correct functioning of controlling that are relevant to protection as well as protection functions for the current converter are provided.

25. The device according to claim 20, wherein said control means is realized on a discrete-time basis.

26. The device according to claim 20, wherein said adaptive PI controller and said status controller form a single controller.
